(19) United States
(12) Patent Application Publication
(10) Pub. No.: US 2009/0006223 A1
(43) Pub. Date: Jan. 1, 2009

(54) Method and system for checking a bill of material

(75) Inventors: Ming-Yuan Liu, Taipei (TW); Chih-Pin Wei, Taipei (TW); Hui-Chun Tsai, Taipei (TW)

Correspondence Address: BACON & THOMAS, PLLC, 625 SLATERS LANE, FOURTH FLOOR, ALEXANDRIA, VA, 22314-1176, US

(73) Assignee: INVENTEC CORPORATION, Taipei (TW)

(21) Appl. No.: 11/896,516

(22) Filed: Sep. 4, 2007

(30) Foreign Application Priority Data
Jun. 28, 2007 (TW) 96123598

(51) Int. Cl. G06Q 10/00

(52) U.S. Cl. 705/29

(57) ABSTRACT

A method and a system for checking a bill of material (BOM) are provided. Firstly, a transforming unit transforms an initial configuration list of a product into a BOM. Next, a model number corresponding to the product is chosen from an input unit. Then, the product is pictorialized by a pictorializing unit according to the model number and the BOM to generate and display a virtual machine of the product on a display unit. Lastly, the displayed virtual machine provides users to determine that the BOM is correct or not.

This application claims the benefit of Taiwan application Serial No. 96123598, filed Jun. 28, 2007, the subject matter of which is incorporated herein by reference.

### BACKGROUND OF THE INVENTION

1. Field of the Invention

The invention relates in general to a checking method and system, and more particularly to a method and a system for checking a bill of material (BOM).

2. Description of the Related Art

Along with the advance in products and the versatile needs of consumers, the build-to-order (BTO) or the configure-to-order (CTO) marketing-production model is widely used by both the original and the OEM manufacturers to satisfy the market demand and provide products and services to consumers in an efficient manner. The above marketing-production model not only satisfies the versatile needs of consumers but also releases the manufacturers and the distributors of inventory pressure and reduces their inventory investment.

In addition, by means of an information system, the production and assembly of products are made faster and more flexible so as to provide more personalized products and keep consumers' loyalty in response to the trend of customer orientation. However, if the information used in the information system is incorrect and results in an erroneous bill of material (BOM), the production and assembly of the products will be severely affected. Normally, erroneous information will not be found until the quality control (QC) stage in a large-scale production, hence incurring more manufacturing cost. Therefore, how to assure the correctness of information during the manufacturing process is essential to both the original brand manufacture (OBM) manufacturer and the original equipment manufacture (OEM) manufacturer.

### SUMMARY OF THE INVENTION

The invention is directed to a method and a system for checking a bill of material (BOM) by displaying a virtual machine of a product according to the generated BOM to provide a user to view and determine if the BOM is correct or not. Furthermore, a material database is updated so as to generate an updated BOM.

According to a first aspect of the present invention, a method for checking a BOM is provided. The checking method includes the following steps. Firstly, an initial configuration list of a product is transformed into a BOM. Next, a model number corresponding to the product is chosen. Then, the product is pictorialized according to the model number and the BOM to generate a virtual machine of the product. Lastly, the virtual machine is displayed for a user to determine the BOM is correct or not according to the displayed virtual machine.

According to a second aspect of the present invention, a system for checking a BOM is provided. The checking system includes a transforming unit, an input unit, a pictorializing unit, and a display unit. The transforming unit is for transforming an initial configuration list of a product into a BOM. The input unit is for choosing a model number corresponding to the product. The pictorializing unit is for pictorialing the product according to the model number and the BOM to generate a virtual machine of the product. The display unit is for displaying the virtual machine for a user to determine if the BOM is correct or not according to the displayed virtual machine.

The invention will become apparent from the following detailed description of the preferred but non-limiting embodiments. The following description is made with reference to the accompanying drawings.

### BRIEF DESCRIPTION OF THE DRAWINGS

FIG. 1 is a block diagram of a BOM checking system according to a preferred embodiment of the invention;

FIGS. 2A and 2B are flowcharts of a BOM checking method according to a preferred embodiment of the invention.

### DETAILED DESCRIPTION OF THE INVENTION

Referring to 1, a block diagram of a BOM checking system according to a preferred embodiment of the invention is shown. The BOM checking system includes an input unit 110, a transforming unit 130, a pictorializing unit 150, and a display unit 170. The transforming unit 130 is for transforming an initial configuration list O of a product into a BOM Tbr. The input unit 110 is for choosing a model number corresponding to the product M. The pictorializing unit 150 is for pictorializing the product according to the model number M and the BOM Tbr to generate a virtual machine of the product G. The display unit 170 is for displaying the virtual machine G for a user to view and determine if the BOM Tbr is correct or not according to the displayed virtual machine G.

The input unit 110 of the present embodiment of the invention is for inputting an initial configuration list O which includes a description of a number of component parts e of the product. Examples of description include the name, the size, the specification, the make, the model, the features, and other functional or structural descriptions.

The BOM checking system of the present embodiment of the invention further includes a material database 140. The material database 140 having a parts number reference table B and a material rule table R(u) is linked to the transforming unit 130 for providing the parts number b and material rules r corresponding to each component part according to the description of each component part to the transforming unit 130. Examples of the material rules r include “a certain component part has to go with some certain dependent parts”, “the parts of a certain make has to labeled with the trade mark of the certain make”, “a certain circuit design needs to be changed due to the addition or deletion of a certain component part”, “a certain structural design needs to be changed due to the addition or deletion of a certain component part”, and other empirical rules derived from practical experience.

The transforming unit 110 of the present embodiment of the invention finds a number of parts numbers and material rules corresponding to each component part e from the material database 140 according to the description of each component part e, and then transforms the initial configuration list O into the BOM Tbr according to the parts number b and material rules r corresponding to a number of component parts e provided by the material database 140. The BOM Tbr includes a number of parts numbers b and dependent parts d of the component parts e. The dependent parts d are generated according to the material rules r.

For example, if the chosen component part is a “3G wireless network card”, then the corresponding material rule is “3G wireless network card needs to go with an antenna”. Furthermore, according to the material rule, the dependent parts corresponding to the chosen component part (a 3G wireless network card) is an antenna. Therefore, the correctness of the material rules provided by the material database 140 largely affects the correctness of the BOM Tbr. However, under the build-to-order (BTO) or the configure-to-order (CTO) marketing-production mode, the component parts of a product and the dependent parts thereof as well as the material rules may need to be changed to fit the versatile needs of the customers. As a result, the component parts e of a product and the dependent parts d thereof are very likely to be changed and so is the BOM Tbr likely to be changed accordingly. To avoid the material database 140 providing an incorrect or incomplete information which may lead to an erroneous BOM Tbr, the present embodiment of the invention further uses a pictorializing unit 150 for combining the parts information of the BOM Tbr with the information of the model configuration of the product to display a 3-D virtual machine of the product to provide a mechanism for verifying the correctness of the BOM Tbr.

The pictorializing unit 150 of the present embodiment of the invention for generating a virtual machine G includes a model configuration database 152, a parts picture database 154, and an integrating unit 156. The model configuration database 152 is linked to an input unit 110 for storing and providing a number of model configuration pictures Gm corresponding to the model number M to the display unit 170. The parts picture database 154 is linked to a transforming unit 130 for storing a lot of pictures of the component parts and the dependent parts to provide the pictures Ge of the component parts and the pictures Gd of the dependent parts corresponding to component parts to the display unit 170 according to the BOM Tbr. The integrating unit 156 is for combining the pictures Ge of the component parts and the pictures Gd of the dependent parts to the model configuration picture Gm to generate the virtual machine G in the display unit 170.

Meanwhile, the user can check the virtual machine G to determine if any of the dependent parts d are misplaced, omitted or redundant so as to verify the correctness of the material rules r. Let the above example be used again. If the chosen component part is a “3G wireless network card”, then the corresponding material rule is “the 3G wireless network card needs to go with an “antenna”. The antenna of the 3G wireless network card has a sharp tip. If the specification of the antenna is not specified in the material rules, then the BOM Tbr may adopt an antenna whose top end is flat. However, such error in the BOM Tbr still can be detected during the process of viewing and checking the virtual machine G.

The input unit 110 of the present embodiment according to the invention is for inputting an updated information U. The material database 140 corrects an erroneous material rule corresponding to BOM Tbr according to the updated information U for updating the material rule table R(u) and providing an updated material rule r′ to the transforming unit 130. The transforming unit 130 further updates the material rules r′ according to the parts number b and transforms the initial configuration list O into an updated BOM Tbr′. The system for checking a BOM disclosed in the present embodiment of the invention further includes an output unit 160 for outputting a BOM Tbr or an updated BOM Tbr′.

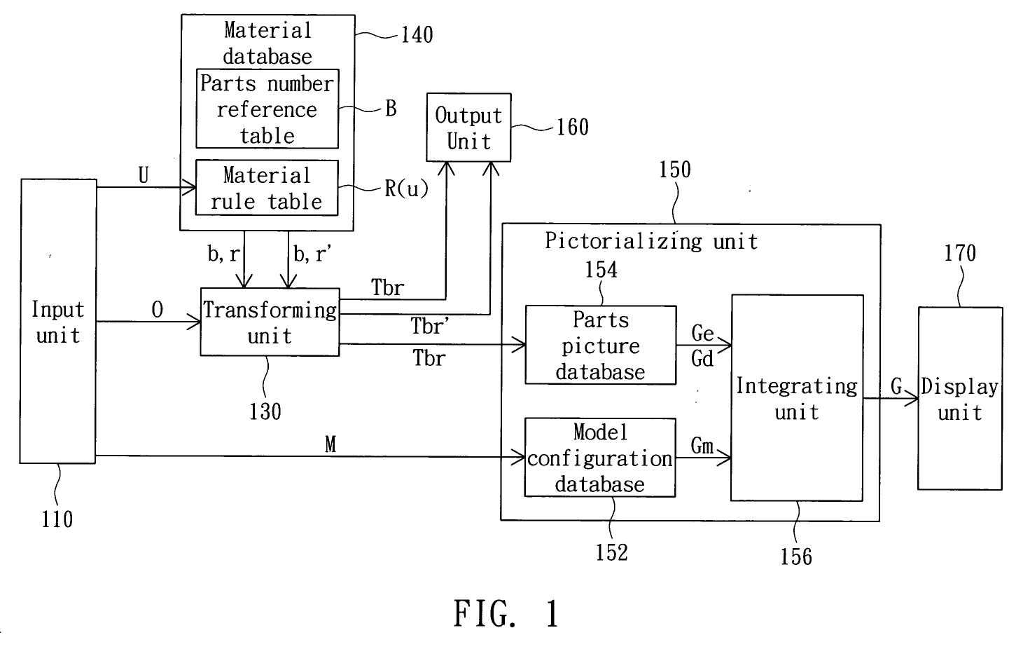

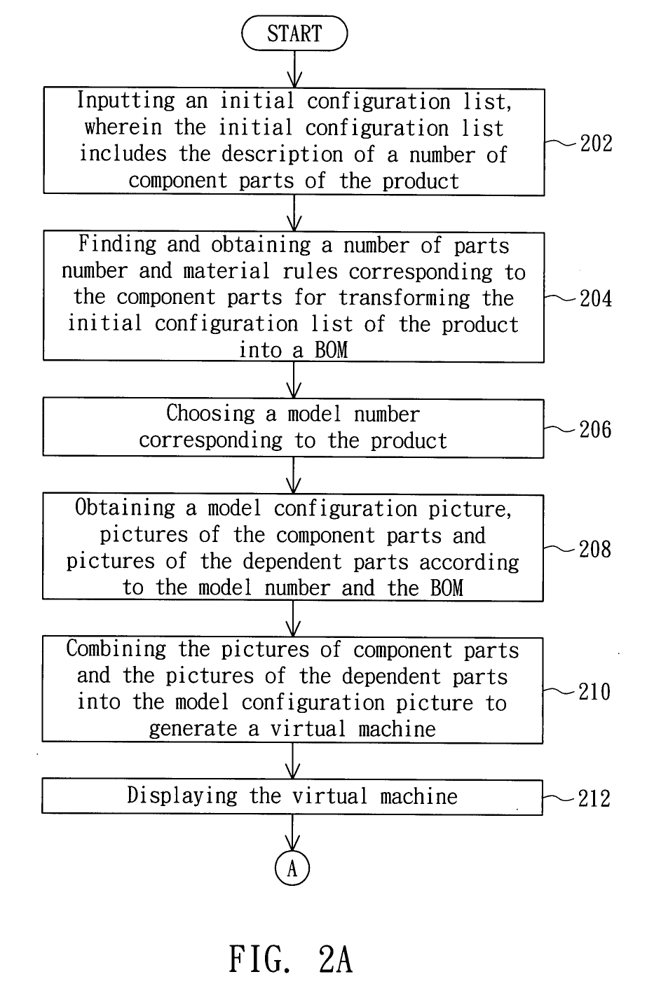

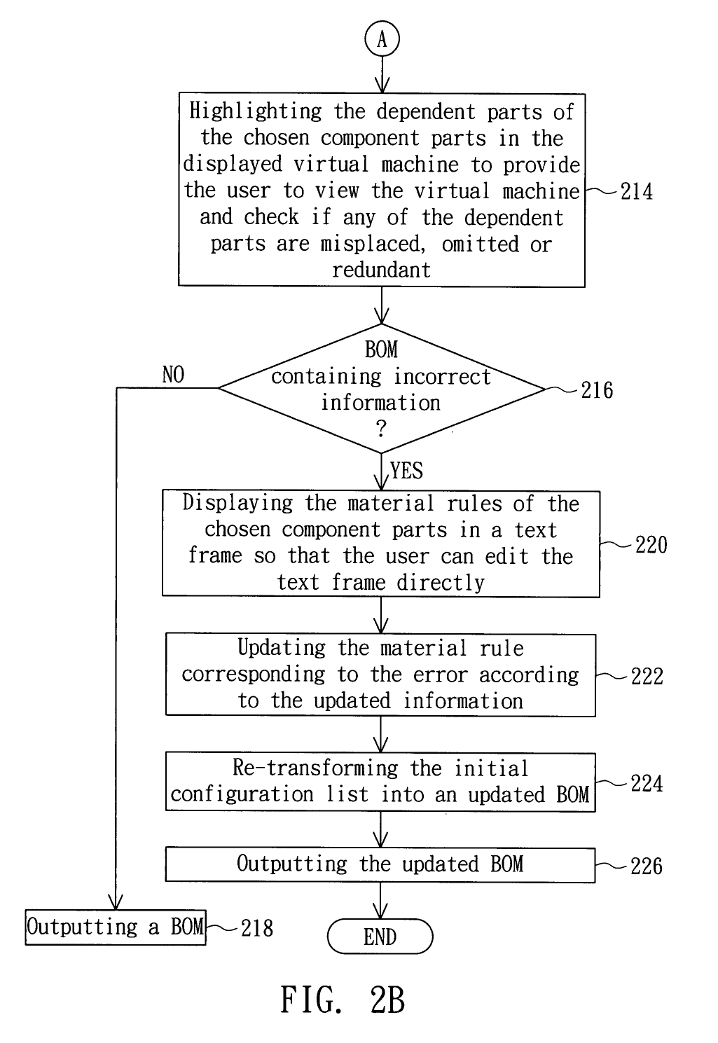

Referring to 2A and 2B, flowcharts of a BOM checking method according to a preferred embodiment of the invention are shown. Also, referring to FIG. 1. Firstly, the checking method begins at step 202, an initial configuration list O is inputted, wherein the initial configuration list includes the description of a number of component parts e of the product. Next, the method proceeds to step 204, a number of parts number b and material rules r corresponding to a number of component parts e are found and obtained for transforming the initial configuration list O of the product into a BOM Tbr. Next, the method proceeds to step 206, a model number M corresponding to the product is chosen. Then, the method proceeds to step 208, a model configuration picture, a number of pictures Ge of the component parts and pictures Gd of the dependent parts are obtained according to the model number M and the BOM Tbr. Afterwards, the method proceeds to step 210, the pictures Ge of the component parts and the pictures Gd of the dependent parts are combined to the model configuration picture Gm to generate a virtual machine G. Subsequently, the method proceeds to step 212, the virtual machine G is displayed.

Next, the method proceeds to step 214, the dependent parts d of the component parts e chosen from the displayed virtual machine G by the user are highlighted in the displayed virtual machine G for the user to view the virtual machine G and check if any of the dependent parts d are misplaced, omitted or redundant for verifying the correctness of the material rules r. If the BOM is determined to be correct in step 216, then the method proceeds to step 218, a BOM Tbr is outputted. If the BOM Tbr is determined to have at least one error, the method proceeds to step 220, an updated information U is inputted, preferably, the material rules r of the chosen component parts e are displayed in a text frame so that the user can edit the text frame directly. Then, the method proceeds to step 222, the material rule corresponding to the error is corrected according to the updated information U inputted thereto. Preferably, the material rules r of the chosen component parts are corrected according to the edited text frame for updating the material database 140. Next, the method proceeds to step 224, the initial configuration list O is re-transformed into an updated BOM Tbr′. Lastly, the method proceeds to step 226, the updated BOM Tbr′ is outputted. The method is terminated.

According to the method and system for checking a bill of material disclosed in the above embodiments of the invention, a pictorializing unit is combined with a BOM generating system to form a pictorialized BOM checking mechanism, which generates a fast and correct BOM. The pictorializing unit is for pictorializing the BOM generated by the system, so that the user can determine if the BOM is correct or not by viewing and checking a virtual machine of a product according to the generated BOM. Moreover, the material database is updated to assure the correctness of the BOM and meet the clients' versatile needs.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for checking a bill of material (BOM), the method comprising:
transforming an initial configuration list of a product into a BOM;
choosing a model number corresponding to the product;
pictorializing the product according to the model number and the BOM to generate a virtual machine of the product; and
displaying the virtual machine for a user to determine if the BOM is correct or not according to the displayed virtual machine.

2. The checking method according to claim 1, wherein the transforming step further comprises:
inputting the initial configuration list comprising a description of a plurality of component parts of the product; and
finding a plurality of parts numbers and material rules corresponding to the components according to the description of the component parts for transforming the initial configuration list into the BOM.

3. The checking method according to claim 2, wherein the BOM comprises the parts numbers of the component parts and a plurality of dependent parts generated according to the material rules.

4. The checking method according to claim 3, wherein after the step of displaying the virtual machine, the method further comprises:
highlighting the dependent parts of the component parts chosen from the displayed virtual machine by the user in the displayed virtual machine so as to provide the user to view the virtual machine and check if any of the dependent parts are misplaced, omitted or redundant.

5. The checking method according to claim 4, wherein after the step of displaying the virtual machine, the method further comprises:
displaying the material rules of the chosen component parts in a text frame so as to provide the user to edit the text frame directly.

6. The checking method according to claim 5, wherein the step of pictorializing the product further comprises:
displaying a model configuration picture of the model number;
displaying a plurality of pictures of the component parts;
displaying a plurality of pictures of the dependent parts; and
combining the pictures of the component part and the pictures of the dependent parts into the model configuration picture to generate the virtual machine.

7. The checking method according to claim 6, further comprising:
linking to a model configuration database; and
obtaining the model configuration picture from the model configuration database.

8. The checking method according to claim 6, further comprising:
linking to a parts picture database; and
searching the parts picture database according to the BOM to obtain the pictures of the component parts and the pictures of the dependent parts.

9. The checking method according to claim 6, further comprising:
linking to a material database; and
searching the material database according to the description of the component parts to obtain the parts numbers and the material rules corresponding to the component parts.

10. The checking method according to claim 1, further comprising:
outputting the BOM.

11. The checking method according to claim 9, further comprising:
correcting the material rules of the chosen component parts according to the edited text frame to update the material database.

12. The checking method according to claim 11, further comprising:
re-transforming the initial configuration list into an updated BOM according to the updated material database; and
outputting the updated BOM.

13. A system for checking a bill of material (BOM), comprising:
a transforming unit for transforming an initial configuration list of a product into a BOM;
an input unit for choosing a model number corresponding to the product;
a pictorializing unit for pictorializing the product according to the model number and the BOM to generate a virtual machine of the product; and
a display unit for displaying the virtual machine for a user to determine if the BOM is correct or not according to the displayed virtual machine.

14. The checking system according to claim 13, wherein the input unit is for inputting the initial configuration list comprising a description of a plurality of component parts of the product.

15. The checking system according to claim 14, wherein the transforming unit is for finding a plurality of parts numbers and material rules corresponding to the component parts according to the description of the component parts for transforming the initial configuration list into the BOM.

16. The checking system according to claim 15, wherein the BOM comprises the parts numbers of the component parts and a plurality of dependent parts generated according to the material rules.

17. The checking system according to claim 16, wherein the display unit further highlights the dependent parts of the component parts chosen from the displayed virtual machine by the user in the displayed virtual machine so as to provide the user to view the virtual machine and check if any of the dependent parts are misplaced, omitted or redundant.

18. The checking system according to claim 16, wherein the display unit further displays the material rules of the chosen component parts in a text frame so as to provide the user to edit the text frame directly.

19. The checking system according to claim 18, further comprising:
a material database connected to the transforming unit, wherein the material database has a parts number reference table and a material rule table for providing the parts numbers and the material rules corresponding to the component parts to the transforming unit according to the description of the component parts.

20. The checking system according to claim 13, wherein the pictorializing unit comprises:
a model configuration database connected to the input unit for providing a model configuration picture of the model number to the display unit; and
a parts picture database connected to the transforming unit for providing the pictures of the component parts and the pictures of the dependent parts corresponding to the component parts to the display unit according to the BOM.

21. The checking system according to claim 20, wherein the pictorializing unit further comprises:
an integrating unit for combining the pictures of the component parts and the pictures of the dependent parts pictures into the model configuration picture to generate the virtual machine in the display unit.

22. The checking system according to claim 19, wherein the material database corrects the material rules of the chosen component parts according to the edited text frame for updating the material rule table and providing an updated material rule to the transforming unit.

23. The checking system according to claim 19, wherein the transforming unit further re-transforms the initial configuration list into an updated BOM according to the parts numbers and the updated material rules.

24. The checking system according to claim 23, wherein the system further comprises:
an output unit for outputting the BOM and the updated BOM.
